(19) United States
(12) Patent Application Publication
(10) Pub. No.: US 2024/0038040 A1
(43) Pub. Date: Feb. 1, 2024

(54) SECURITY APPARATUS

(71) Applicant: Essence Security International (E.S.I.) Ltd., Herzlia Pituach (IL)

(72) Inventors: Elly GAZAL, Tel Mond (IL); Ohad AMIR, Herzlia (IL)

(21) Appl. No.: 18/254,350

(22) PCT Filed: Nov. 29, 2021
(86) PCT No.: PCT/IL2021/051420

§ 371 Date: May 24, 2023

(30) Foreign Application Priority Data
Nov. 29, 2020 (IL) 279073

(51) Int. Cl. G08B 13/196

(52) U.S. Cl. CPC G08B 13/19682; G08B 13/19636

(57) ABSTRACT

A security apparatus is disclosed comprising one or more processors 300 configured to, in response to identifying a need for outputting light-obscuring material: instruct an output device 116 to output light-obscuring material into an environment; and instruct a verification device 120 to cause the verification device to detect a signal having a wavelength greater than an average particle size of the light-obscuring material so as to enable verification of whether an object of interest is in the environment when the object is obscured by the light-obscuring material.

### RELATED APPLICATION

This application claims the benefit of priority of Israel Patent Application No. 279073 filed on 29 Nov. 2020, the contents of which are incorporated herein by reference in their entirety.

### FIELD OF INVENTION

The present invention relates to a security apparatus.

### BACKGROUND

Motion sensors are designed to monitor a defined area, which may be outdoors (e.g., entrance to a building, a yard, and the like), and/or indoors (e.g., within a room, in proximity of a door or window, and the like). Motion sensors may be used for security purposes, to detect intruders based on motion in areas in which no motion is expected, for example, an entrance to a home at night.

Some security systems employ a motion sensor in the form of a passive infrared (PIR) detector to sense the presence of a heat-radiating body (i.e., such a heat-radiating body would typically indicate the presence of an unauthorized person) in its field of view, and then issue a deterrent such as an audible alarm sound. However, in some circumstances there can be a need for a stronger and more effective deterrent.

Reference to any prior art in this specification is not an acknowledgement or suggestion that this prior art forms part of the common general knowledge in any jurisdiction, or globally, or that this prior art could reasonably be expected to be understood, regarded as relevant/or combined with other pieces of prior art by a person skilled in the art.

### SUMMARY

One or more aspects of the present invention relate to security systems and apparatus configured to output smoke or fog or the like, for example, as a deterrent in response to detection of a security related event (e.g. sensing an intruder's motion). However, in order to determine whether the deterrent is having a desired effect of warding off an intruder, it is a further aspect of the invention to use a verification device to try to detect the intruder through the smoke/fog to determine, for example, if they are still in the monitored environment.

In accordance with a first aspect of the invention there is provided a security apparatus comprising:
one or more processors configured to, in response to identifying a need for outputting light-obscuring material:
instruct an output device to output light-obscuring material into an environment; and
instruct a verification device to cause the verification device to detect a signal having a wavelength greater than an average particle size of the light-obscuring material so as to enable verification of whether an object of interest is in the environment when the object is obscured by the light-obscuring material.

Embodiments of the first aspect of the invention may therefore relate to security systems in which light-obscuring material may be output as a deterrent to ward off an intruder and a verification device can be used to detect the intruder through the light-obscuring material by using a wavelength greater than an average particle size of the light-obscuring material. As such, the verification device can be used to verify the presence and/or motion of the intruder when a visible verification is not possible.

It will be understood that the light-obscuring material is configured to obscure at least visible light (i.e. visible light-obscuring material). As such a visible light camera will not be able to image any objects through the light-obscuring material, or at least not well. However, a visible light camera may be useful in capturing one or more images before the object is fully obscured by the light-obscuring material and/or before the environment is filled with light-obscuring material.

The verification device described above may be configured to detect a signal at least at a time after at least one of: 15 seconds, 20 seconds, 30 seconds, 40 seconds, 50 seconds or 60 seconds after the output device has commenced outputting the light-obscuring material. In which case, it may be more likely that the environment will have filled with the light-obscuring material making a visible light verification of an intruder difficult or even impossible.

It will be understood that enabling the verification of whether an object of interest is in the environment may comprise enabling verification of whether the object of interest is not in the environment. More specifically, embodiments of the invention may be configured to enable one or more of: a positive verification of an object in the environment (i.e. the object is present) or a negative verification of an object in the environment (i.e. the object is not present).

The instruction to the verification device may be generated before or at substantially a same time as the instruction to the output device.

The instruction to the verification device may be generated after a pre-determined delay from transmission of the instruction to the output device.

The one or more processors may be further configured to activate the verification device by switching the verification device from an off or sleep state to an operational state in response to the instruction to the verification device.

The identifying of the need may be in response to receiving a trigger.

The one or more processors may be configured to receive the trigger from a control hub, server or monitoring station.

The apparatus may further comprise the verification device.

The verification device may be configured to transmit data based on the detected signal to a monitoring device for verification of whether the object of interest is in the environment.

The verification device may be operable to detect wavelengths greater than 7 microns.

The average particle size of the light-obscuring material may be equal to or smaller than a maximum wavelength of a near-infrared range of an electromagnetic spectrum. For example, the light-obscuring material may have a particle size of between 0.2 microns and 1 micron and an average particle size within that range. The near-infrared range is generally considered to have a maximum wavelength of 2.5 microns.

The verification device may be passive and operable to detect a signal generated in the environment

The verification device may comprise a thermal camera. The thermal camera may be configured, for example, to detect blackbody radiation from a person having a wavelength of typically around 9.55 microns.

The verification device may comprise a near-infrared camera.

The verification device may be active and operable to emit a signal into the environment and to detect said signal after reflection from one or more objects in the environment.

The verification device may comprise a radar device. For example, the radar device may be configured to obtain a point cloud of data points, which indicate locations of received reflections.

The verification device may comprise a sonar device or lidar device.

The radar device, lidar and/or the sonar device may be configured for ranging so as to be able to represent a location of the object within a region captured by the respective lidar/radar/sonar device. This is in contrast with a Doppler only device that is only able to provide information on movement within the region.

The apparatus may further comprise the output device.

The light-obscuring material may be output to generate fog. For example, the output device may be configured to emit water or water-based droplets to form fog after emission into the environment.

In some embodiments, the light-obscuring material may comprise (or be) particulate matter.

The light-obscuring material may comprise smoke. In some embodiments, the light-obscuring material may be smoke.

The output device and the verification device may be provided in a common housing.

The apparatus may further comprise a detector configured to detect a security related event.

The detector may be provided in the common housing.

In some embodiments, two or more items from the group consisting of: the output device, the verification device and the detector; may be physically connected. For example, the items may be connected via a mount or wire.

The detector may be configured to provide an indication of the security related event to the one or more processors.

The receipt of the trigger may be in response to the security related event.

The detector may comprise at least one item selected from a group consisting of: a motion sensor, a vibration sensor, a magnetic sensor, a proximity sensor, a threshold sensor, a door sensor, a window sensor, a passive infrared sensor, a thermal camera, a video camera, an active reflected wave detector, a radar device, a sonar device and a lidar device.

In accordance with a second aspect of the invention there is provided a security system comprising the apparatus of the first aspect and at least one device selected from a group consisting of: a control hub; a server; and a monitoring station; wherein the at least one device is configured to transmit a trigger, identifying the need for outputting light-obscuring material, to the one or more processors.

The at least one device may be the monitoring station configured to receive data based on the signal detected by the verification device for verification of whether the object of interest is in the environment.

The object of interest may be a person.

The monitoring station may be configured to present the data to an operator for human analysis to determine whether the object of interest is present in the environment.

The monitoring station may be configured to receive data from a detector and/or camera and to present the data to an operator via a display, such that an operator may decide whether or not to trigger the output of the light-obscuring material.

The data received from the camera may correspond to one or more images taken in response to detection of a security related event.
In accordance with a third aspect of the invention there is provided a method comprising:
   responding to identification of a need for outputting light-obscuring material by:
   instructing an output device to output light-obscuring material into an environment; and
   instructing a verification device to cause the verification device to detect a signal having a wavelength greater than an average particle size of the light-obscuring material so as to enable verification of whether an object of interest is in the environment when the object is obscured by the light-obscuring material.

It will be understood that the steps of instructing the output device and instructing the verification device may take place in any order or substantially simultaneously.

In accordance with a fourth aspect of the invention there is provided a non-transitory computer-readable medium comprising instructions operable by one or more processors to carry out the method of the third aspect.

In accordance with a fifth aspect of the invention there is provided a security apparatus comprising:
one or more processors configured to, in response to identifying a need for outputting light-obscuring material;
instruct an output device to output light-obscuring material into an environment; and
instruct a verification device to cause the verification device to detect a signal at least after the output device has commenced outputting the light-obscuring material.

The verification device may comprise a visible light camera.

The verification device may be configured to detect a signal at least during a time within a time range from 3 to 60 seconds after the output device has commenced outputting the light-obscuring material.

The time range may be from 3 to 20 seconds after the output device has commenced outputting the light-obscuring material.

The verification device may comprise a device to detect a signal having a wavelength greater than an average particle size of the light-obscuring material so as to enable verification of whether an object of interest is in the environment when the object is obscured by the light-obscuring material.

The verification device may detect the signal having a wavelength greater than an average particle size of the light-obscuring material at least at a time that is more than 20 seconds after the output device has commenced outputting the light-obscuring material.

The verification device may detect the signal having a wavelength greater than an average particle size of the light-obscuring material at least at a time that is more than 60 seconds after the output device has commenced outputting the light-obscuring material.

In accordance with a sixth aspect of the invention there is provided a security system comprising the apparatus of the fifth aspect and at least one device selected from a group consisting of: a control hub; a server; and a monitoring station; wherein the at least one device is configured to transmit a trigger, identifying the need for outputting light-obscuring material, to the one or more processors.

In accordance with a seventh aspect of the invention there is provided a method comprising:
responding to identification of a need for outputting light-obscuring material by:
instructing an output device to output light-obscuring material into an environment; and
instructing a verification device to cause the verification device to detect a signal at least after the output device has commenced outputting the light-obscuring material.

In accordance with an eighth aspect of the invention there is provided a non-transitory computer-readable medium comprising instructions operable by one or more processors to carry out the method of the seventh aspect.

The verification device may be or comprise a visible light camera. For example, the visible light camera may be configured to capture at least one image (e.g. a still image or video) before the object is fully obscured by the light-obscuring material and/or before the environment is filled with light-obscuring material.

The verification device may be configured to detect a signal at least within one of: 10 seconds, 15 seconds, 20 seconds, 30 seconds and 60 seconds after the output device has commenced outputting the light-obscuring material. In such embodiments the verification device be configured to detect the signal at least after an amount time (e.g. 3 seconds or 5 seconds) has elapsed since the output device has commenced outputting the light-obscuring material, so as to determine how the intruder has reacted to the outputting of the light-obscuring material. For example, if the verification device comprises a visible light camera it may be possible to see an intruder react to the outputting of the light-obscuring material before the intruder is substantially or completely obscured by the light-obscuring material (which may take, for example, 20 seconds or so). Thereafter, a verification device configured to detect a signal having a wavelength greater than an average particle size of the light-obscuring material may be useful to monitor the intruder through the obscuration material. Accordingly, in some embodiments, the verification device may comprise a visible light camera for an initial verification period (e.g. before complete or substantial obscuration) and additionally or alternatively a detector for detecting signals at a different wavelength to that of visible light (e.g. an IR camera, radar, sonar, lidar device) for a subsequent verification period (e.g. after complete or substantial obscuration).

The verification device may be instructed to detect a signal before as well as after the output device has commenced outputting the light-obscuring material. The verification device may be configured to continually detect a signal or may be configured to detect a signal at one or more pre-defined times or intervals. The instruction to detect a signal at least after the output device has commenced outputting the light-obscuring material need not instruct the verification device when to detect the signal. For example the instruction need not define a time, but may instead merely cause the verification device to detect the signal at least after the output device has commenced outputting the light-obscuring material by virtue of when the instruction is provided to the verification device.

Any features described above in relation to the first to fourth aspects may be similarly applied to any of the fifth to eighth aspects and vice versa.

In relation to the non-transitory computer-readable storage medium defined above, the instructions may be provided on one or more carriers. For example there may be one or more non-transient memories, e.g. a EEPROM (e.g. a flash memory) a disk, CD- or DVD-ROM, programmed memory such as read-only memory (e.g. for Firmware), one or more transient memories (e.g. RAM), and/or a data carrier(s) such as an optical or electrical signal carrier. The memory/memories may be integrated into a corresponding processing chip and/or separate to the chip. Code (and/or data) to implement embodiments of the present disclosure may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language, or any other code for executing by any one or more other processing device, e.g. such as those exemplified herein.

As will be appreciated from the description herein, each processor described above may be comprised of a plurality of processing units/devices.

Each processor may be provided in a dedicated processing device, e.g. a central processing unit (CPU) or may be provided as part of any other device described above. For example, one or more of the processors described may be provided in the output device, verification device, detector, control hub, server or monitoring station. In which case, the same processor may perform other actions in the device.

These and other aspects will be apparent from the embodiments described in the following. The scope of the present disclosure is not intended to be limited by this summary nor to implementations that necessarily solve any or all of the disadvantages noted.

Any features described in relation to one aspect of the invention may be applied to any one or more other aspect of the invention.

### BRIEF DESCRIPTION OF THE SEVERAL VIEWS OF THE DRAWINGS

For a better understanding of the present disclosure and to show how embodiments may be put into effect, reference is made to the accompanying drawings in which:

FIG. 1 illustrates a security system according to an embodiment of the invention;

FIG. 2 is a flow chart of a method according to an embodiment of the invention;

FIG. 3 is a more detailed schematic diagram of the system of FIG. 1;

FIG. 4 shows a timing diagram of an embodiment of the invention, in which a CPU identifies a need for a deterrent;

FIG. 5 shows a timing diagram of an embodiment of the invention, in which a monitoring station identifies a need for a deterrent;

FIG. 6 shows a timing diagram for an embodiment of the invention similar to that shown in FIG. 4 but in which a verification device is instructed before an output device; and

FIG. 7 shows a timing diagram for an embodiment of the invention similar to that shown in FIG. 5 but in which a verification device is instructed before an output device.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized, and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims and their equivalents.

In the following embodiments, like components are labelled with like reference numerals.

In the following embodiments, the term memory is intended to encompass any computer readable storage medium and/or device (or collection of data storage mediums and/or devices). Examples of memories include, but are not limited to, optical disks (e.g., CD-ROM, DVD-ROM, etc.), magnetic disks (e.g., hard disks, floppy disks, etc.), memory circuits (e.g., EEPROM, solid state drives, random-access memory (RAM), etc.), and the like.

As used herein, except wherein the context requires otherwise, the terms “comprises”, “includes”, “has” and grammatical variants of these terms, are not intended to be exhaustive. They are intended to allow for the possibility of further additives, components, integers or steps.

The functions or algorithms described herein are implemented in hardware, software or a combination of software and hardware in one or more embodiments. The software comprises computer executable instructions stored on computer readable carrier media such as a memory or other type of storage device. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, microcontroller or other type of processing device or combination thereof.

Specific embodiments will now be described with reference to the drawings.

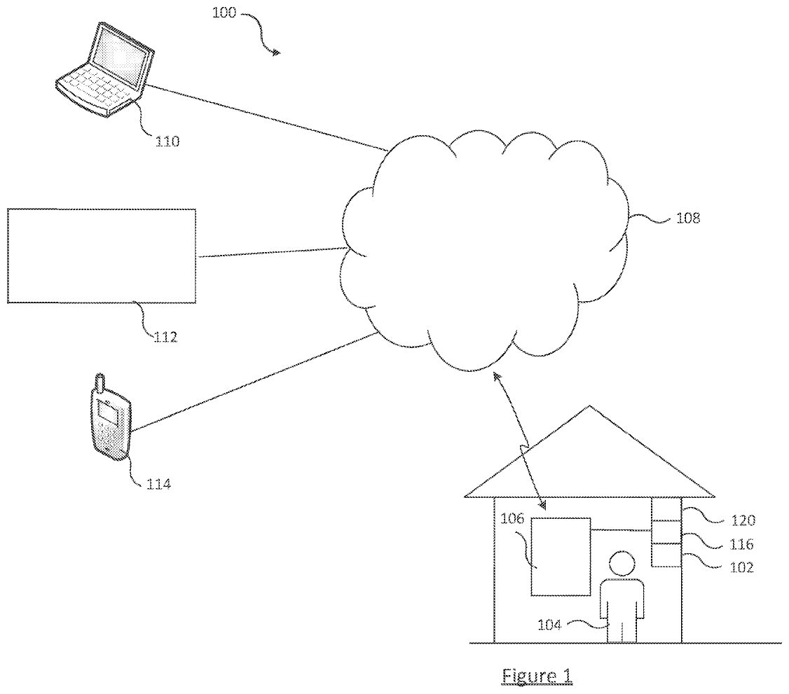

FIG. 1 illustrates a security system 100 according to an embodiment of the invention. The security system 100 comprises a detector 102 arranged to monitor an environment, which in this case is an interior of a home. In other embodiments, the environment may be or comprise, for example, an outdoor space (e.g. garden or car park) associated with a residential or commercial property, or a public space (e.g. park or train station). In some embodiments, the environment may be or comprise an indoor space such as inside a building (e.g. one or more rooms of the building), a shop floor, a public building or other enclosed space.

In the embodiment of FIG. 1, detector 102 is mounted to an interior wall of the home and is arranged to monitor an interior space in which a target object (e.g. a person 104) may be present. In some embodiments, multiple detectors 102 may be provided and may be distributed around the environment being monitored.

As shown in FIG. 1, the detector 102 is coupled to a control hub 106 by way of a wired and/or wireless connection. Preferably, the detector 102 is coupled wirelessly to the control hub 106 which may be in the form of a control panel.

The control hub 106 is configured to transmit data to a remote monitoring station 110 over a network 108. An operator at the remote monitoring station 110 may respond as needed to incoming notifications which may be generated by the detector 102 and may also respond to incoming notifications generated by other similar devices which monitor other environments. In other embodiments, the detector 102 may transmit data to the remote monitoring station 110 without interfacing with the control hub 106. In both examples, the data from the detector 102 may be sent (from the detector 102 or control hub 106) directly to the remote monitoring station 110 or via a remote server 112. The remote monitoring station 110 may comprise for example a laptop, notebook, desktop, tablet, smartphone or the like. The monitoring station is illustrating as a single device, but as will be appreciated by a person skilled in the art, it is often a system comprising a plurality of interface terminals attended by respective operators. The terminals may be at and/or remote from a processing system that receives and sorts incoming and outgoing data and/or calls.

Additionally or alternatively, the control hub 106 may transmit data to a remote personal computing device 114 over the network 108. A user of the remote personal computing device 114 is associated with the environment monitored by the detector 102—for example, the user may be the homeowner of the environment being monitored, or an employee of the business whose premises are being monitored by the detector 102. In other embodiments, the detector 102 may transmit data to the remote personal computing device 114 without interfacing with the control hub 106. In both examples the data from the detector 102 may be sent (from the detector 102 or control hub 106) directly to the remote personal computing device 114 or via the server 112. The remote personal computing device 114 may be for example a laptop, notebook, desktop, tablet, smartphone or the like.

The network 108 may be any suitable network, which has the ability to provide a communication channel between the detector 102 and/or the control hub 106 to the remote devices 110, 112, 114. For example, the network 108 may be a cellular communication network such as may be configured for 3G, 4G or 5G telecommunication.

In some embodiments, no control hub 106 may be present. In which case, the detector 102 may be coupled wirelessly to the server 112 (e.g. via a cellular communication network) and the server 112 may perform the functions of the control hub 106 as described.

In addition, the system 100 comprises an output device 116 and a verification device 120. In this embodiment, the output device 116 and the verification device 120 are collocated with the detector 102 on the interior wall of the home 20. The output device 116 and the verification device 120 are coupled to the control hub 106 by way of a wired and/or wireless connection. Preferably, the output device 116 and the verification device 120 are coupled wirelessly to the control hub 106. In some embodiments, the output device 116, verification device 120 and detector 102 share a common interface for communication with the control hub 106. In other embodiments, the output device 116 and/or verification device 120 may be located remotely from the detector 102.

In yet other embodiments, the output device 116 and verification device 120 may be integrated into the detector 102. In other words, a single unit may comprise the detector 102, output device 116 and verification device 120. The single unit may have at least one of a cellular modem for direct communication to one or more of the remote devices 110, 112, 114, and a local RF transceiver for communication with an on-premises control hub 106.

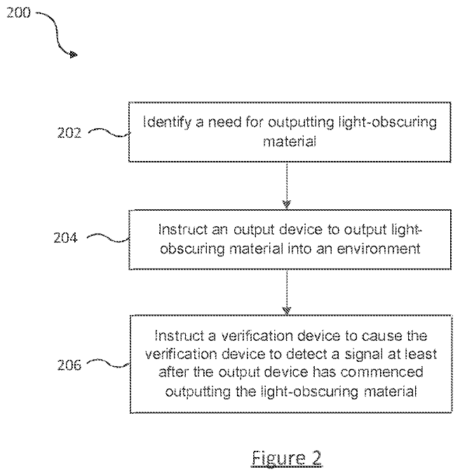

General operation of the control hub 106 is outlined in the flow diagram 200 of FIG. 2. In this case, the control hub 106 comprises one or more processors configured for responding to identification of a need for outputting light-obscuring material, in accordance with step 202. The identification of the need may be in response to receiving a trigger, for example, from within the control hub 106, from the detector 102, from the server 112 or from the monitoring station 110. The trigger may be issued, directly or indirectly, in response to a security related event, for example, detection of an object (e.g. intruder) by the detector 102.

In a step 204, the one or more processors instruct the output device 116 to output light-obscuring material into the environment. The light-obscuring material may take the form of fog, smoke or particulate matter configured to obscure visible light so as to disorientate, slow, stop, worry or confuse an intruder. The light-obscuring material may have a particle size of between 0.2 microns and 1 micron and an average particle size within that range.

In a step 206, the one or more processors instruct a verification device to cause the verification device to detect a signal at least after the output device has commenced outputting the light-obscuring material. In some embodiments, the verification device will be configured to detect a signal having a wavelength greater than an average particle size of the light-obscuring material so as to enable verification of whether an object of interest is in the environment when the object is obscured by the light-obscuring material. The signal may be in the form of a sound wave or an electromagnetic wave. For example, the verification device may be in the form of an infrared camera configured to detect blackbody radiation from a person, which is generally at a wavelength of around 9.55 microns. In some embodiments, the verification device may be in the form of a radar device, lidar device or a sonar device configured to emit a signal into the environment and to detect said signal after reflection from one or more objects in the environment. For example, the radar device may be configured to obtain a point cloud of data points, which indicate locations of received reflections. More specifically, the radar device may be configured for ranging so as to be able to represent a location of the object within a region captured by the radar device. In some embodiments, the verification device may comprise a visible light camera (e.g. operable to detect signals in a visible portion of the electromagnetic spectrum). In embodiments in which the verification device is a visible light camera, verification may be possible for at least an initial verification period (e.g. before complete/substantial obscuration). In embodiments, in which the verification device comprises a means to detect a signal having a wavelength greater than an average particle size of the light-obscuring material (e.g. a thermal camera or radar device), verification may be possible for at least a subsequent verification period (e.g. after complete/substantial obscuration). Optionally such a means to detect a signal having a wavelength greater than an average particle size of the light-obscuring material may additionally or alternatively be used during the initial verification period. Using a visible light camera during the initial verification period, however, has an advantage in terms of the ability or ease with which an identity of a person may be identified by the signals. In embodiments in which such an initial verification period is used to capture signals, the subsequent verification period may or may not be used, depending on the embodiment.

It will be understood that the steps of instructing the output device and instructing the verification device may take place in any order or substantially simultaneously.

Although in the present embodiment, the one or processors for performing the method of FIG. 2 are provided in a control hub 106, in other embodiments, one or more of the steps of FIG. 2 may be performed by one or processors provided in the server 112, the monitoring station 110, the detector 102, the output device 116 or the verification device 120. In one exemplary embodiment, the one or more processors are integrated into a single unit having the detector 102, the output device 116 and the verification device 120. In such an embodiment, the trigger may be received from at least one of: the control hub 106, the detector 102, the server 112 or the monitoring station 110.

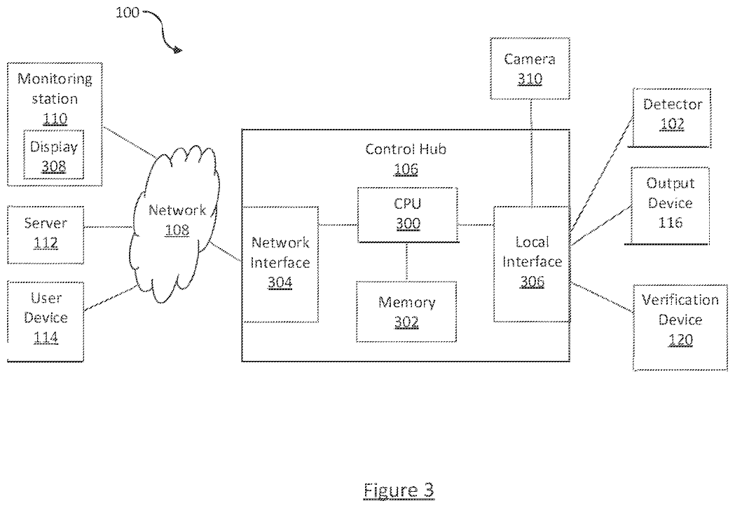

Further details of operation of the system 100 will be described below with reference to FIG. 3, which shows an exemplary schematic diagram of the system 100. The control hub 106 comprises a processor in the form of a central processing unit (CPU) 300 connected to a memory 302, a network interface 304 and a local interface 306. In this embodiment, the CPU 300 comprises a processor configured to carry out the method of FIG. 2 and the memory 302 is a non-transitory computer-readable storage medium comprising instructions operable by the CPU 300 to carry out the method of FIG. 2.

The functionality of the CPU 300 described herein is implemented in code (software) stored on a memory (e.g. memory 302) comprising one or more storage media, and arranged for execution on a processor comprising one or more processing units. That is, the control hub 106 may comprise one or more processing units for performing the processing steps described herein. The storage media may be integrated into and/or separate from the CPU 300. The code is configured to perform operations in line with embodiments discussed herein, when fetched from the memory and executed on the processor. In some embodiments, some or all of the functionality of the CPU 300 may be implemented in dedicated hardware circuitry (e.g. ASIC(s), simple circuits, gates, logic, etc.) and/or configurable hardware circuitry like a FPGA. In other embodiments (not shown) the one or more processing units that execute the processing steps described herein may be located in one or more other devices in the system 100. The processor may be comprised of distributed processing devices, which may for example comprise any one or more of the processing devices or units referred to herein. The distributed processing devices may be distributed across two or more devices shown in the system 100. Thus, some or all of the functionality of the CPU 300 may be performed in, for example, a detector, an output device, a monitoring station, a server, a user device or a camera.

FIG. 3 shows the CPU 300 being connected through the local interface 306 to a detector 102 and a camera 310. While in the illustrated embodiment the detector 102 and camera 310 are separate from the CPU 300, in other embodiments, one or more processing aspects of the detector 102 and/or camera 310 may be provided by a processor that also provides the CPU 300, and resources of the processor may be shared to provide the functions of the CPU 300 and the processing aspects of the detector 102 and/or camera 310. Similarly, functions of the CPU 300, such as those described herein, may be performed in the detector 102 and/or the camera 310.

It will be appreciated from the below that in some embodiments, one or more additional detectors 102 may be provided to monitor a plurality of locations in the environment. The detector 102 in this embodiment is a passive infrared (PIR) motion detector. In various embodiments, the detector 102 could comprise one or more of: a motion sensor, a vibration sensor, a magnetic sensor, a proximity sensor, a door sensor, a window sensor, a passive infrared sensor, a thermal camera or a video camera (e.g. for video motion detection), or an active reflected wave detector. Such an active reflected wave detector, may be a ranging detector, a radar device, a sonar device or a lidar device or may lack ranging capabilities by providing only Doppler detection (e.g. Doppler based motion detectors). In some embodiments, there may be both a motion detector (e.g. a PIR detector) and an active reflected wave detector having ranging capabilities (e.g. a radar detector) for identifying a position of an object of interest. In some other embodiments, an active reflected wave detector may provide both positioning capabilities via ranging, and motion detecting capabilities. The motion detection may be provided by identifying change in an identified position or by detector motion based on the Doppler effect. In the latter case, the active reflected wave detector may consume more power in when performing ranging measurements than when performing Doppler only measurements. In any case, the active reflected wave detector in an activated state (i.e. when turned on and operational) and performing ranging measurements, may consume more power than the amount of power consumed by motion detection (PIR or Doppler based). To save power, the active reflected wave detector may be configured to only perform ranging measurements in response to a detected motion. In some embodiments, three or more detectors may be provided, for example, one in each room of a building.

In some embodiments, the CPU 300 is configured to control the camera 310 to capture at least one image (represented by image data) of the environment. The images may be still images or moving images in the sense of a video capture. The camera 310 is preferably a visible light camera in that it senses visible light. In other embodiments, the camera 310 senses infrared light. One example of a camera which senses infrared light is a night vision camera which operates in the near infrared (e.g. wavelengths in the range 0.7-1.4 μm) which requires infrared illumination e.g. using infrared LEDs which are not visible to an intruder. Another example of a camera which senses infrared light is a thermal imaging camera which is passive in that it does not require an illumination source, but rather, senses light in a wavelength range (e.g. a range comprising 7 to 15 μm, or 7 to 11 μm) that includes wavelengths corresponding to blackbody radiation from a living person (around 9.55 μm). The camera 310 may be capable of detecting both visible light and, for night vision, near infrared light.

It will be appreciated from the below that in some embodiments, the camera 310 may not be present.

As also shown in FIG. 3 the CPU 300 is connected through the local interface 306 to an output device 116 and a verification device 120. In other embodiments, two or more output devices and/or two or more verification devices may be provided, for example, distributed around and/or within a building. The output device 116, verification device 120 and CPU 300 may, together make up a security apparatus, optionally along with other components of the system 100, for example the detector 102 and/or the camera 310.

FIG. 3 also shows the CPU 300 being connected through the network interface 304 to the network 108, where it is then connected separately to the monitoring station 110, the remote server 112 and the remote personal computing device in the form of a user device 114. Thus, the network interface 304 may be used for communication of data to and from the control hub 106.

The local interface 306 may operate using a local or short-range communication protocol, for example WIFI, Bluetooth, a proprietary protocol, protocol in accordance with IEEE standard 802.15.4, or the like. The network interface 304 may operate using a cellular communication protocol such as 3G, 4G or 5G. In some embodiments, the local interface 306 and the network interface 304 may be combined in a single module and may operate using a common communication protocol. In some embodiments, the local interface 306 may not be required and instead only the network interface 304 may be required for all communications. This may be the case where the detector 102 is configured to communicate directly with the CPU 300 when the CPU 300 is located in a remote server 112 or monitoring station 110, for example, where there is no local control hub 106. In other embodiments in which a single unit comprises at least the output device 116 and a verification device 120 and/or camera 310, and in some embodiments also comprising the detector 102, the single unit may comprise the CPU 300, memory 302 and network interface 304 but optionally there may be no local interface 306.

A housing may be provided around any one or more of the control hub 106, the detector 102, the output device 116, the verification device 120 and the camera 310. Accordingly, any of these components may be provided together or separately. Separate components may be coupled to the CPU 300 by way of a wired or wireless connection. Further, the outputs of the detector 102 and/or the camera 310 may be wirelessly received from/via an intermediary device that relays, manipulates and/or in part produces their outputs.

In some embodiments, the CPU 300 is configured to detect motion in the environment based on an input received from the detector 102. If motion is detected, the CPU 300 will identify a need for output of light-obscuring material. Thus, the detection of motion by the detector 102 may serve as a trigger for instructing the output of light-obscuring material. In some embodiments, the trigger may be received by the CPU 300 directly from the detector 102. In other embodiments, the output from the detector 102 may be relayed to the remote monitoring station 110 (either directly or via the control hub 106) and an operator at the remote monitoring station 110 may decide whether or not to trigger the output of light-obscuring material. To help with forming this decision the operator may be presented with data from the detector 102 and/or from the camera 310 via a display 308. If it is decided to proceed with output of light-obscuring material, the monitoring station 110 may relay the trigger to the output device 116 either directly or via the control hub 106. The CPU 300 may then identify a need for output of light-obscuring material based on that received trigger. In all cases, a CPU 300 may be configured to instruct the output device 116 to output light-obscuring material into the environment.

The output device 116 is configured to output light-obscuring material into the environment to act as a deterrent to an intruder. In the present embodiment, the output device 116 is configured to output particulate matter, for example smoke. Upon emission, the particles are suspended in the air to hinder a person's visibility. In the present embodiment, the light-obscuring material has a particle size of between 0.2 microns and 1 micron and an average particle size within that range. In other embodiments, the light-obscuring material is output to generate fog. As such, the output device 116 may be configured to emit water droplets to form fog after emission into the environment.

In some embodiments, the output device 116 may be configured to also output visual and/or audible deterrents, such as a flashing light and siren. In some embodiments, additional output devices may be provided to output visual and/or audible and/or other deterrents. In accordance with the invention, the CPU 300 will instruct the verification device 120 to cause the verification device 120 to detect a signal from the environment having a wavelength greater than an average particle size of the light-obscuring material so as to enable verification of whether an object of interest (e.g. intruder) is in the environment when the object is obscured by the light-obscuring material.

The instruction to the verification device 120 may be transmitted directly from the control hub 106 or from the monitoring station 110 or server 112 or from the detector 102 or output device 116. Accordingly, the instruction to the verification device 120 may be transmitted before, on or after output of the light-obscuring material has commenced. In some embodiments, the instruction to the verification device 120 may serve to activate the verification device 120 by switching the verification device 120 from an off or sleep state to an operational state.

The verification device 120 may be operable to detect wavelengths greater than 7 microns. In the present embodiment, the verification device 120 is a thermal camera. Such a thermal camera detects blackbody radiation from a person at a wavelength, which is generally at about 9.55 microns. In other embodiments, the verification device 120 may be active reflected wave detector (e.g. a radar, sonar device or lidar). Notably, the verification device 120 is configured to detect signals that are able to pass the light-obscuring material (smoke) from an object such as a person. The signals may be used to detect and monitor the person visually or non-visually (e.g. via image recognition and/or video motion detection). For example, by the signals being at wavelengths having a size greater than that of the obscuration material, there will be minimal or negligible reflections of the signals by the obscuration material.

The verification device 120 may be configured to transmit data based on the detected signal to the monitoring station 110 for verification of whether the object of interest (e.g. intruder) is in the environment. The monitoring station 110 may be configured to display infrared data from the thermal camera to provide a thermal image of the environment to the operator. In which case, the operator may be able to identify the intruder and monitor their movement in the fog.

In some embodiments, two or more of: the detector 102, the camera 310 and the verification device 120 may be the same device. For example, a thermal camera may be configured to operate as the detector 102 (e.g. to detect a security related event and raise a trigger) as well as operating as the camera 310 (e.g. to take infrared images, even when no fog is present) and can operate as the verification device 120 (e.g. to allow verification of whether an intruder is present when obscured by the fog). As such, the components illustrated in FIG. 3 should be understood to be representative of the functionality of the system 100 and should not be taken to require corresponding distinct devices.

Where the detector 102 and/or verification device 120 is an active reflected wave detector, it may operate in accordance with one of various reflected wave technologies. In operation, the CPU 300 and/or monitoring station 112 may use the input from the active reflected wave detector to determine the presence (i.e. location) and/or movement of the object (e.g. person 104).

Preferably, the active reflected wave detector is a radar sensor. The radar sensor may use millimeter wave (mmWave) sensing technology. The radar is, in some embodiments, a continuous-wave radar, using, for example, frequency modulated continuous wave (FMCW) technology. Such a chip with such technology may be, for example, Texas Instruments Inc. part number IWR6843. The radar may operate in microwave frequencies, e.g. in some embodiments a carrier wave in the range of 1-100 GHz (76-81 Ghz or 57-64 GHz in some embodiments), and/or radio waves in the 300 MHz to 300 GHz range, and/or millimeter waves in the 30 GHz to 300 GHz range. In some embodiments, the radar has a bandwidth of at least 1 GHz. The active reflected wave detector may comprise antennas for both emitting waves and for receiving reflections of the emitted waves, and in some embodiments different antennas may be used for the emitting compared with the receiving.

As will be appreciated the active reflected wave detector is an “active” detector in the sense of it relying on delivery of waves from an integrated source in order to receive reflections of the waves. Thus, the active reflected wave detector need not be limited to being a radar sensor. In other embodiments, the active reflected wave detector may comprise a lidar sensor, or a sonar sensor.

The active reflected wave detector being a radar sensor is advantageous over other reflected wave technologies in that radar signals may transmit through some materials, e.g. wood or plastic, but not others—notably water, which is important because humans are mostly water. This means that the radar can potentially “see” a person in the environment even if they are behind an object of a radar-transmissive material. Thus, it will be possible for the radar to sense objects through the light-obscuring material.

In relation to the active reflected wave detector, for each reflected wave measurement, for a specific time in a series of time-spaced reflected wave measurements, the reflected wave measurement may include a set of one or more measurement points that make up a “point cloud”, the measurement points representing reflections from respective reflection points from the environment. In each of the embodiments described herein the point cloud may be analysed by one or more processors (e.g. a CPU) in the active reflective wave detector device. Such analysis may include for example detecting, identifying (e.g. as potentially human or not), locating (e.g. by coordinates and/or with respect to a region of interest) and/or tracking an object. This may be the case for example in embodiments where such a device indicates the output of such analysis, over a wireless communication, to another device, e.g. control hub 106, monitoring station 110, or the remote server 112. In embodiments described herein, for example immediately hereinafter, in which such analysis is conducted by the CPU 300 of the control hub 106, it will be appreciated that in each such embodiment some or all of the analysis may instead be performed in the active reflective wave detector device.

In some embodiments, the active reflected wave detector provides an output to the CPU 300 for each captured frame as a point cloud for that frame. Each point in the point cloud may be defined by a 3-dimensional spatial position from which a reflection was received, and defining a peak reflection value, and a Doppler value from that spatial position. Thus, a measurement received from a reflective object may be defined by a single point, or a cluster of points from different positions on the object, depending on its size.

In some embodiments, such as in the examples described herein, the point cloud represents only reflections from moving points of reflection, for example based on reflections from a moving target. That is, the measurement points that make up the point cloud represent reflections from respective moving reflection points in the environment. This may be achieved for example by the active reflected wave detector using moving target indication (MTI). Thus, in these embodiments there must be a moving object in order for there to be reflected wave measurements from the active reflected wave detector (i.e. measured wave reflection data), other than noise. In other embodiments, the CPU 300 receives a point cloud from the active reflected wave detector for each frame, where the point cloud has not had pre-filtering out of reflections from moving points. Preferably, for such embodiments, the CPU 300 filters the received point cloud to remove points having Doppler frequencies below a threshold to thereby obtain a point cloud representing reflections only from moving reflection points. In both of these implementations, the CPU 300 accrues measured wave reflection data which corresponds to point clouds for each frame whereby each point cloud represents reflections only from moving reflection points in the environment.

In some embodiments, no moving target indication (or any filtering) is used. In these implementations, the CPU 300 accrues measured wave reflection data, which corresponds to point clouds for each frame whereby each point cloud can represent reflections from both static and moving reflection points in the environment.

In a map of reflections, the size of the point may represent an intensity (magnitude) of energy level of the radar reflections. Different parts or portions of the body reflect the emitted signal (e.g. radar) differently. For example, generally, reflections from areas of the torso are stronger than reflections from the limbs. Each point represents coordinates within a bounding shape for each portion of the body. Each portion can be separately considered and have separate boundaries, e.g. the torso and the head may be designated as different portions. The point cloud can be used as the basis for a calculation of a reference parameter or set of parameters which can be stored instead of or in conjunction with the point cloud data for a reference object (e.g. human) for comparison with a parameter or set of parameters derived or calculated from a point cloud for radar detections from an object (e.g. human).

When a cluster of measurement points are received from an object in the environment, a location of a particular part/point on the object or a portion of the object, e.g. its centre, may be determined by the CPU 300 from the cluster of measurement point positions having regard to the intensity or magnitude of the reflections (e.g. a centre location comprising an average of the locations of the reflections weighted by their intensity or magnitude). A reference body may have a point cloud from which its centre has been calculated and represented by a location. In this embodiment, the torso of the body is separately identified from the body and the centre of that portion of the body is indicated. In other embodiments, the body can be treated as a whole or a centre can be determined for each of more than one body part e.g. the torso and the head, for separate comparisons with centres of corresponding portions of a scanned body.

In one or more embodiments, the object's centre or portion's centre is in some embodiments a weighted centre of the measurement points. The locations may be weighted according to a Radar Cross Section (RCS) estimate of each measurement point, where for each measurement point the RCS estimate may be calculated as a constant (which may be determined empirically for the reflected wave detector) multiplied by the signal to noise ratio for the measurement divided by R⁴, where R is the distance from the reflected wave detector antenna configuration to the position corresponding to the measurement point. In other embodiments, the RCS may be calculated as a constant multiplied by the signal for the measurement divided by R⁴. This may be the case, for example, if the noise is constant or may be treated as though it were constant. Regardless, the received radar reflections in the exemplary embodiments described herein may be considered as an intensity value, such as an absolute value of the amplitude of a received radar signal.

In any case, the weighted centre, WC, of the measurement points for an object may be calculated for each dimension as:

$$WC = \frac{1}{{\sum }_{n = 1}^{N} {W}_{n}} {\sum }_{n = 1}^{N} ( {W}_{n} {P}_{n} )$$

### Where:

N is the number of measurement points for the object;
Wₙ is the RCS estimate for the n^{th} measurement point; and
Pₙ is the location (e.g. its coordinate) for the n^{th} measurement point in that dimension.
Operation of the system 100 will now be described in relation to some particular, non-limiting, scenarios.

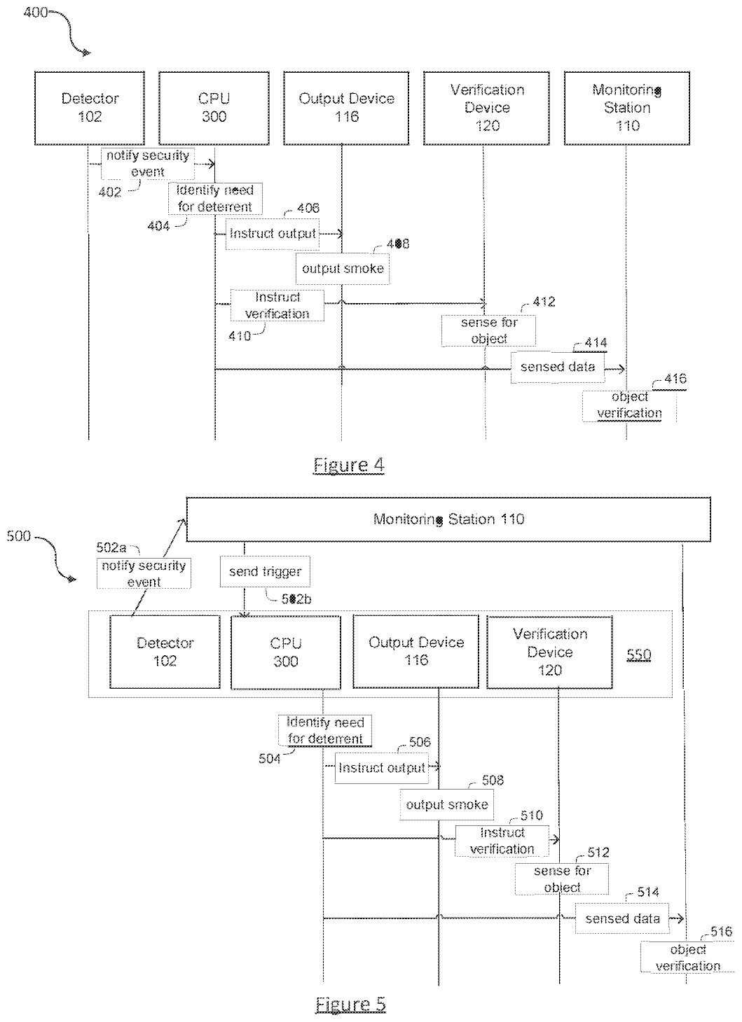

A timing diagram of a first scenario 400 is illustrated in FIG. 4, in which the CPU 300 of the system 100 identifies a need for a deterrent. In this scenario, any two or more of the detector 102, CPU 300, output device 116 and verification device 120 may be provided in a single unit or apparatus. This is assumed to be the case for the exemplary embodiments described hereinafter. For such embodiments, steps described as being performed by the CPU may be performed on one or more processors that are shared by the detector 102, output device 116 and/or verification device 120. However, in other embodiments the CPU 300 may be in a control hub that is separate from the detector 102, output device 116 and verification device 120. In some of such other embodiments, the detector 102, output device 116 and verification device 120 may nonetheless be in the same unit or a plurality of units. For example, they may each be in distinct units, or in another example, the output device 116 and verification device 120 may be in one unit and the detector 102 may be in a different unit.

The detector 102 may be a motion detector as described above, e.g. a PIR motion detector. In a step 402 the detector 102 senses motion in its field of view and sends a notification that a security related event has occurred, to the CPU 300. Based on the notification, the CPU 300 identifies a need for a deterrent in a step 404. In other embodiments, the detector 102 may output a signal periodically, where the signal is indicative of a sensed condition and the amplitude of the signal is used to determine at the CPU 300 whether a PIR signal representing a person has been sensed. In some embodiments, the CPU 300 may check whether the system 100 has been armed (e.g. alarm-enabled) in order to identify the need for a deterrent. If the system 100 is not armed (e.g. if a person is home and active in the environment) the CPU 300 may disregard the notification from the detector 102. However, if the system 100 is armed, the notification from the detector 102 will trigger the CPU 300 to instruct the output device 116 to output light-obscuring material in a step 406. The output device 116 will then begin emitting smoke in step 408. The generation of the smoke may be configured to last for a predefined amount of time. In some embodiments, bursts of smoke may be emitted at predefined intervals.

In this embodiment, the CPU 300 is configured to instruct the verification device 120, after the output of the smoke has begun, in a step 410. The verification device 120, which is a thermal camera, will then sense for an object at step 412 by detecting signals having a wavelength greater than an average particle size of the smoke so as to effectively see through the smoke to detect the intruder. The sensed data is then provided from the verification device 120 to the CPU 300 and then relayed to the monitoring station 110 in a step 414. The sensed data may be sent directly from the CPU 300 to the monitoring station 110, for example, over a cellular network, or it may be relayed via the control hub 106 (not shown) and, optionally, via the server 112 (not shown). The monitoring station 110, or a person at the monitoring station 110, will then perform a step 416 of object verification to determine, from the sensed data, if an intruder can be identified or not.

In other embodiments, no notification of a security related event may be sent by the detector 102 and, instead, the CPU 300 may identify a need for a deterrent, for example, if a user has activated a panic button.

FIG. 5 shows a timing diagram of a second scenario 500, in which the monitoring station 110 triggers the need for a deterrent. In this scenario, the CPU 300 is located in a unit 550 along with the detector 102, the output device 116 and the verification device 120. In other embodiments, the CPU 300 may be provided separately in a control hub 106 (not shown), however, the functionality described here may be the same regardless of whether the CPU 300 is located in the unit 550 or control hub 106. The detector 102 is a motion detector as described above. Optionally, one or more of the detector 102, the output device 116 and the verification device 120 may be provided separately from the unit 550. In a step 502a the detector 102 senses motion in its field of view and sends a notification that a security related event has occurred, to the monitoring station 110 (either directly or via the CPU 300 or the control hub 106, not shown). Based on the notification, the monitoring station 110, or an operator at the monitoring station 110, determines a need for a deterrent and sends a trigger to the CPU 300 in a step 502a. In this embodiment, the monitoring station 110 obtains image data from the camera 310 (not shown) so that an operator may determine visually whether an intruder is present and the deterrent should be output. In this example, the camera is a visible light camera, which aids in identification of the person. In other examples, the camera may be a near infrared or thermal camera. If the operator confirms, via an input received by the monitoring station 110, that the deterrent should be output, the monitoring station 110 will transmit a trigger to the CPU 300. On receipt of the trigger, the CPU 300 will identify the need for the deterrent in a step 504 and will instruct the output device 116 to output the light-obscuring material in a step 506. The trigger to the CPU 300 may be relayed directly, e.g. via a cellular network (i.e. using a cellular modem in the apparatus of the CPU 300) or via the control hub 106 (not shown) (i.e. using a relatively local protocol at the apparatus, e.g. WLAN, ZigBee, Bluetooth, a proprietary local protocol). The output device 116 will then begin emitting smoke in step 508.

In this embodiment, the CPU 300 is configured to instruct the verification device 120, after the output of the smoke has begun, in a step 510. The verification device 120, which is a thermal camera, will then sense for an object at step 512 by detecting signals having a wavelength greater than an average particle size of the smoke so as to effectively see through the smoke to detect the intruder. The sensed data is then provided from the verification device 120 to the CPU 300 which is configured to send the sensed data to the monitoring station 110 in a step 514. The sensed data may be sent directly from the CPU 300 to the monitoring station 110, for example, over a cellular network, or it may be relayed via the control hub 106 (not shown) and, optionally, via the server 112 (not shown). The monitoring station 110 will then perform a step 516 of object verification to determine, from the sensed data, if an intruder can be identified or not.

In other embodiments, the CPU 300 (whether in the control hub 106 or monitoring station 110 or otherwise) may be configured to instruct the output device 116 at the same time as instructing the verification device 120.

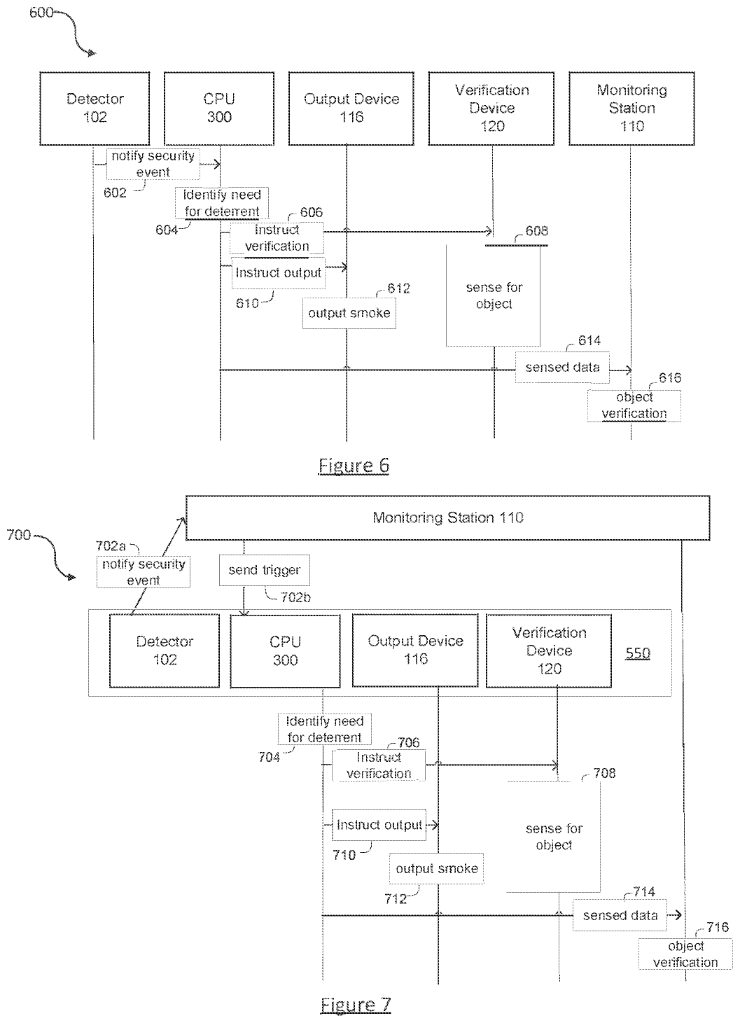

FIG. 6 shows a timing diagram for a third scenario 600, similar to that shown in FIG. 4 but in which the verification device 120 is instructed before the output device 116. Thus, in a step 602 the detector 102 senses motion in its field of view and provides a notification that a security related event has occurred, to the CPU 300 (which may be in the control hub 106, the monitoring station 110 or another apparatus, for example, in a unit comprising the detector 102, the output device 116 and the verification device 120). Based on the notification, the CPU 300 identifies a need for a deterrent in a step 604. If the system 100 is armed, the notification from the detector 102 will trigger the CPU 300 to instruct the verification device 120, before instructing the output of the smoke, in a step 606. The verification device 120, which is a thermal camera, will then begin sensing for an object at step 608 by detecting signals having a wavelength greater than an average particle size of the smoke so as to effectively see through the smoke, when it is generated, to detect the intruder.

The CPU 300 then instructs the output device 116 to output light-obscuring material in a step 610. The output device 116 will then begin emitting smoke in step 612. As the verification device 120 is already sensing for an object in step 608, the verification device 120 will continue to sense data before, during and, optionally, after the output of the smoke in step 612 and will provide the sensed data to the CPU 300 for relaying to the monitoring station 110 in a step 614. The sensed data may be sent directly from the CPU 300 to the monitoring station 110, for example, over a cellular network, or it may be relayed via the control hub 106 (not shown) and, optionally, via the server 112 (not shown). The monitoring station 110, or a person at the monitoring station 110, will then perform a step 616 of object verification to determine, from the sensed data, if an intruder can be identified or not.

FIG. 7 shows a timing diagram for a fourth scenario 700, similar to that shown in FIG. 5 but in which the verification device 120 is instructed before the output device 116. As for FIG. 5, the CPU 300 is located in a unit 550 along with the detector 102, the output device 116 and the verification device 120 in this embodiment. In this scenario, the detector 102 is a motion detector as described above. In a step 702a the detector 102 senses motion in its field of view and sends a notification that a security related event has occurred, to the monitoring station 110 (either directly or via the CPU 300 or control hub 106, not shown) and the monitoring station 110 sends a trigger to the CPU 300 in a step 702b. Based on the trigger, the CPU 300 identifies a need for a deterrent in a step 704. As before, the monitoring station 110 obtains image data from the camera 310 (not shown), which may be a visible light and/or near infrared camera, so that an operator may determine visually whether an intruder is present and the deterrent should be output. If the operator confirms, via an input received by the monitoring station 110, that the deterrent should be output, the monitoring station 110 sends the trigger to the CPU 300. The CPU 300 first instructs the verification device 120, before instructing the output of the smoke, in a step 706. The verification device 120, which is a thermal camera, will then begin sensing for an object at step 708 by detecting signals having a wavelength greater than an average particle size of the smoke so as to effectively see through the smoke, when it is generated, to detect the intruder.

The CPU 300 then instructs the output device 116 to output light-obscuring material in a step 710. The output device 116 will then begin emitting smoke in step 712. As the verification device 120 is already sensing for an object in step 708, the verification device 120 will continue to sense data before, during and, optionally, after the output of the smoke in step 712 and will provide the sensed data to the CPU 300 for relaying to the monitoring station 110 in a step 714. The sensed data may be sent directly from the CPU 300 to the monitoring station 110, for example, over a cellular network, or it may be relayed via the control hub 106 (not shown) and, optionally, via the server 112 (not shown). The monitoring station 110 will then perform a step 716 of object verification to determine, from the sensed data, if an intruder can be identified or not.

Although in the scenarios described above, the light-obscuring material is smoke, it will be understood that in other embodiments the light-obscuring material may comprise other materials such as fog or other particulate material.

Although in the scenarios described above, the verification device 120 is a thermal camera, it will be understood that in other embodiments the verification device 120 may be near IR camera, or a radar device or other active reflected wave detector. The verification device 120 may be configured to detect signals having a wavelength greater than an average particle size of the light-obscuring material so as to effectively see through the light-obscuring material, after it has been output, to detect the intruder. Additionally or alternatively, the verification device 120 may be configured to capture signals that need not have a wavelength greater than an average particle size of the light-obscuring material (it may be a visible light camera for example), should such signals be detected before complete light obscuration has occurred. This can be achieved by capturing such a signal at least within an initial verification period (of within 15 seconds, for example) after commencement of the output of the light-obscuring material.

It will be understood that in the various embodiments described, there is some kind of security related event (e.g. a detected motion, or an instruction from a device that operates with the system 100) which triggers directly or indirectly the output of the light obscuring material and also sensing by the verification device 120 in order to enable verification of whether an object of interest is or is not in the environment at least after commencement of the output of the light-obscuring material.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Furthermore, features described in relation to one embodiment may be mixed and matched with features from one or more other embodiments, within the scope of the claims.

In addition, any priority document(s) of this application is/are hereby incorporated herein by reference in its/their entirety.

1-32. (canceled)

33. A security apparatus comprising:
one or more processors configured to, in response to identifying a need for outputting light-obscuring material:
instruct an output device to output light-obscuring material into an environment; and
instruct a camera to cause the camera to detect a signal at least after the output device has commenced outputting the light-obscuring material.

34. A security system comprising the apparatus of claim 33 and at least one device selected from a group consisting of: a control hub; a server; and a monitoring station; the at least one device comprising the monitoring station; wherein the at least one device is configured to transmit a trigger to the one or more processors, wherein the one or more processors identifies the need for outputting light-obscuring material based on receiving the trigger,
wherein the monitoring station is configured to receive data from a detector and/or camera and to present the data to an operator via a display, such that an operator may decide whether or not to trigger the output of the light-obscuring material, wherein the received data from the camera corresponds to one or more images taken in response to detection of a security related event,
wherein the monitoring station is further configured to receive data based on the signal detected by the verification device for verification of whether the object of interest is in the environment after the transmitting of the trigger to the one or more processors, wherein the object of interest is a person, wherein the monitoring station is configured to present the data to an operator for human analysis to determine whether the object of interest is present in the environment after the outputting of the light-obscuring material.

35-40. (canceled)

41. A method comprising:
responding to identification of a need for outputting light-obscuring material by:
instructing an output device to output light-obscuring material into an environment; and
on or after commencement of outputting the light-obscuring material by the output device, instructing a camera to cause the camera to detect a signal.

42. A non-transitory computer-readable medium comprising instructions operable by one or more processors to carry out the method of claim 41.

43. The apparatus of claim 33, further comprising a detector configured to detect a security related event, wherein in response to a detected security related event the device is configured to transmit a notification that a security related event has occurred, wherein the identifying of the need is in response to receiving a trigger, wherein the one or more processors are configured to receive the trigger from a control hub, server or monitoring station.

44. The apparatus of claim 43, wherein the detector comprises a motion sensor.

45. The apparatus of claim 33, wherein the instructing of the camera is performed on or after commencement of outputting the light-obscuring material by the output device.

46. The apparatus of claim 33, wherein the one or more processors are further configured to activate the camera by switching the camera from an off or sleep state to an operational state in response to the instruction to the camera.

47. The apparatus of claim 33, wherein the instruction to the camera is generated after a pre-determined delay from transmission of the instruction to the output device.

48. The apparatus of claim 33, wherein detecting a signal at least after the output device has commenced outputting the light-obscuring material comprises detecting a signal at least during a time within a time range from 3 to 60 seconds after the output device has commenced outputting the light-obscuring material.

49. The apparatus of claim 33, further comprising the camera, the wherein the output device, the camera and the detector are provided in a common housing.

50. The apparatus of claim 33, wherein the signal detected by the camera has a wavelength greater than an average particle size of the light-obscuring material so as to enable verification of whether an object of interest is in the environment when the object is obscured by the light-obscuring material.

51. The apparatus of claim 33, wherein the camera comprises a near-infrared camera.

52. The apparatus of claim 33, wherein the camera comprises a visible light camera.

53. The apparatus of claim 33, wherein light-obscuring material comprises smoke.
